(19) United States
(12) Patent Application Publication
(10) Pub. No.: US 2022/0128153 A1
(43) Pub. Date: Apr. 28, 2022

(54) FACE SEAL HAVING ELASTOMERIC RING WITH SURFACE SHAPE FOR IMPROVED SEALING

(71) Applicant: Trelleborg Sealing Solutions Germany GmbH, Stuttgart (DE)

(72) Inventors: Andrea Nicolini, Modena (IT); Nicola Lamanuzzi, Modena (IT)

(73) Assignee: Trelleborg Sealing Solutions Germany GmbH, Stuttgart (DE)

(21) Appl. No.: 17/452,054

(22) Filed: Oct. 22, 2021

Related U.S. Application Data
(60) Provisional application No. 63/106,089, filed on Oct. 27, 2020.
(60) Provisional application No. 63/262,742, filed on Oct. 27, 2021.

(51) Int. Cl. F16J 15/34; F16J 15/38

(52) U.S. Cl. CPC F16J 15/3484; F16J 15/38; F16J 15/3456

(57) ABSTRACT

A face seal assembly includes a pair of identical metal and elastomeric rings. The metal rings are biased towards one another by the elastomeric rings when the face seal assembly is installed. The metal rings each have lapped surfaces that abut one another to create a sealing arrangement. An outside side of each elastomer ring is divided by a second inner diameter surface definingly separating a metal ring engagement side from an environmentally exposed side. The environmentally exposed side of each elastomeric ring has an annularly-shaped concave valley formed in the elastomeric ring, which is facing the concave valley of its oppositely disposed respective elastomeric ring. The concave valley starts from a first annular lip and extends to a maximum offset distance at an annular bottom of the concave valley and ends at a second annular lip. The second annular lip is disposed further back from the first annular lip.

### CROSS-REFERENCE TO RELATED APPLICATIONS

This application claims priority to provisional application 63/106,089, filed Oct. 27, 2020, and provisional application 63/262,742 filed Oct. 19, 2021, the entire contents of which all applications are hereby incorporated in full by these references.

### DESCRIPTION

### Field of the Invention

The present invention generally relates to face seal assemblies. More particularly, the present invention relates to a face seal assembly that uses a novel shape of the elastomeric ring surface exposed to the environmental contaminants to then advantageously improve its sealing characteristics.

### Background of the Invention

A face seal (i.e. a mechanical face seal/an axial face seal) is designed to keep contaminants (i.e. dirt, mud, water, etc.) out of various rotating assemblies, such as for work vehicles. The work vehicle in which the face seal is installed may be, but is not limited to, a tracked vehicle, an excavator, a bulldozer, a heavy truck, an agricultural machine, a tunnel boring machine or a mining machine. Alternatively, face seals may be used in a conveyor, a gearbox, a mixer, a stirrer or a wind-driven power station to name just a few examples.

Many face seal designs have attempted to improve the functionality of the face seal. In particular, Zutz (U.S. Pat. No. 6,494,459) teaches an axial face seal that uses a hollow space 19 behind a set of sealing lips 12, where the hollow space is filled with grease to function as an anti-grinding agent in case dirt was to enter the hollow space 19. These designs, such as Zutz, are always fighting against dirt entering their seal designs. Unfortunately, the end region 13 in Zutz is rounded as dirt can be forced underneath the end region 13. Also, the hollow space 19 creates a weakened area that under pressure can be deformed inwards to allow dirt to once enter and pass by the sealing lips 12.

Vik (U.S. Pat. No. 10,226,963) teaches a face seal with an elastomeric ring 14 and an inner sealing ring 12 as best seen in FIGS. 1-4. If mud and other contaminants were to enter the seal, pressure would be created against the seal-facing wall 44 and cause it to separate from its adjacent surface defined by the hub-side planar wall 36 of the planar ring portion 24 of the inner sealing ring 12. Once again, Vik's design is fighting against contaminants from entering rather than using the contaminants to the seal's advantage.

Contrary to references like Zutz and Vik, no one skilled in the art has created a design that uses the dirt, mud, water and other contaminants to improve the sealing characteristics of the seal rather than fight against them, to which the inventors have now accomplished and are disclosing within this teaching. Accordingly, there is a need for an improved face seal design. The present invention fulfills these needs and provides other related advantages.

### SUMMARY OF THE INVENTION

The following summary of the invention is in regards to the provisional application 63/106,089, filed Oct. 27, 2020, the contents of which are fully incorporated herein with this reference.

The present invention provides an elastomeric ring with a unique surface shape that can mitigate the negative effects of mud and other substances entering a sealed space. The elastomeric ring may be part of a mechanical face seal that is installed, for example, in a work vehicle.

Referring now to the drawings of the '089 provisional application, and more particularly to FIGS. 1 and 2, there is shown an exemplary embodiment of a mechanical face seal, which may be installed in a work vehicle and generally includes a pair of metal rings and a pair of elastomeric rings holding the metal rings together. In the illustrated embodiment, each of the elastomeric rings bears on a respective one of the metal rings. The mechanical face seal is installed in a housing having a first housing part and a second housing part, with the elastomeric ring seating on respective surfaces of each housing part. The work vehicle in which the mechanical face seal is installed may be, but is not limited to, a tracked vehicle, e.g., an excavator or bulldozer, a heavy truck, an agricultural machine, a tunnel boring machine, or a mining machine. It should be appreciated that the mechanical face seal may be installed in an axle of a work vehicle or in applications other than work vehicles, such as conveyor systems. In addition to being installed in an axle, the mechanical face seal may be installed in, for example, a gearbox, a mixer, a stirrer, and/or a wind-driven power station. It should be appreciated that the previously described uses of the mechanical face seal are exemplary only, and the mechanical face seal provided according to the present invention may be used in any appropriate application.

As illustrated, the metal rings may contact one another along respective first sections. The first sections of the metal rings may be biased toward one another by the elastomeric ring, similar to known mechanical face seals. The metal rings may each include a respective second section that extends from the first section. Each of the metal rings may contact the other metal ring through lapped surfaces, with one of the metal rings being fixed and the other metal ring being rotatable. The metal rings may comprise any metal material, including but not limited to steel, aluminum, etc. The elastomeric ring may bear against both the first section and the second section of each metal ring, as illustrated.

The elastomeric ring of the mechanical face seal comprises an elastomer material, such as a polymer, that is flexible to form a seal. As illustrated in greater detail in FIG. 2, each elastomeric ring has a plurality of external surfaces. It should be appreciated that while only one of the elastomeric rings is illustrated in FIG. 2, each elastomeric ring may be similar in size and shape. One of the surfaces may abut the first section of the metal ring and another of the surfaces may partially contact the second section of the metal ring, with the elastomeric ring fitting within a corner between the first section and the second section. Another of the surfaces may face a respective housing part and be spaced therefrom, with yet another surface on the same side having a portion that is spaced from the housing part and another portion that is in contact with the housing part.

Each elastomeric ring also has at least one surface on its inner diameter that has a first end contacting one of the metal rings and a second end that is opposite the first end and contacts one of the housing parts, to seal between the metal ring and the housing part. The surface may have a first flat section including the first end and a second flat section including the second end, the first flat section and the second flat section being out-of-plane with one another. In the illustrated embodiment, the gap between the first housing part and the second housing part defines a gap axis, with the first flat section defining a first axial offset distance from the gap axis and the second flat section defining a second axial offset distance from the gap axis that is greater than the first axial offset distance, i.e., the second flat section is offset from the gap axis more than the first flat section. A valley is defined between the first flat section and the second flat section and represents a region with a maximum axial offset from the gap axis.

The surface may define a curved shape between the valley and each of the flat sections, with the surface defining a first curved section between the valley and the first flat section and a second curved section between the valley and the second flat section. In the first curved section, the surface defines a plurality of arcs each defined about a respective radius. As illustrated, the surface in the first curved section may define a first arc defined about a first radius R1 extending from an imaginary center outside the material of the elastomeric ring and a second arc defined about a second radius R2 extending from an imaginary center inside the material of the elastomeric ring, with the first arc and the second arc being continuous with one another so the surface is a continuous surface. In some embodiments, the second radius R2 defining the second arc is greater than the first radius R1 defining the first arc. In contrast to the curvature of the surface in the first curved section, the surface may define a curvature in the second curved section between the valley and the second flat section that is defined by one or more arcs each having a respective radius that extends from an imaginary center outside the material of the elastomeric ring. As illustrated, the surface in the second curved section may define a third arc having a respective radius R3 that meets a linearly tapered section located between the third arc and the second flat section.

By forming the external surfaces of the elastomeric rings with both a complex curvature in the first curved section and a simple curvature in the second curved section, the elastomeric rings are able to mitigate the negative effects of mud, or other undesirable substances, into the sealed space. Mitigating the negative effects of the mud or other substances into the sealed space can ensure a long-lasting mechanical face seal that does not need to be replaced frequently, if at all, during the lifetime of the machine or other device into which the mechanical face seal is installed. The general shape of the external surfaces of the elastomeric rings address mud and other substance entry into the sealed space from outside through the labyrinth and reduce mud and other substance impact on the external diameter of the metal parts. Additionally, the shape of the elastomeric rings reduces the amount of free space inside the housing, which limits the amount of mud and other substances that can enter the housing in the first place. Thus, the shape of the elastomeric rings can reduce the amount of mud and/or other substances that enter the sealed space and reduce the detrimental effects of mud and/or other substances that enter the sealed space while maintaining a sufficient seal.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Additionally, provisional application 63/262,742 filed Oct. 19, 2021, the entire contents of which are hereby incorporated in full by this reference, shows two different embodiments of the present invention. The first embodiment is captured in pages 1-3 and the second embodiment is captured in pages 4-6. The dimensions and shapes are different between the embodiments, but the overall novelty is the same in that a valley is integrally formed in the elastomeric ring on the environmental side such that any dirt, water, mud or other contaminants can aid in sealing rather than fight against it.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front view of an exemplary elastomeric ring of the present invention;

FIG. 2 is a sectional view taken along lines 2-2 of FIG. 1;

FIG. 3 is an enlarged sectional view taken along lines 3-3 of FIG. 2;

FIG. 4 is a front view of an exemplary metal ring of the present invention;

FIG. 5 is a sectional view taken along lines 5-5 of FIG. 4;

FIG. 6 is an enlarged sectional view taken along lines 6-6 of FIG. 5;

FIG. 7 is a sectional view of an exemplary face seal assembly of the present invention installed in a first and second housing illustrating the separation of the oil side from the mud side;

FIG. 8 is another embodiment of an elastomeric ring, showing the new embodiment in a sectional view similar to FIG. 3;

FIG. 9 is another embodiment of an elastomeric ring, showing the new embodiment in a sectional view similar to FIG. 3;

FIG. 10 is another embodiment of an elastomeric ring, showing the new embodiment in a sectional view similar to FIG. 3; and

FIG. 11 is another embodiment of an elastomeric ring, showing the new embodiment in a sectional view similar to FIG. 3.

### DETAILED DESCRIPTION OF THE PREFERRED EMBODIMENTS

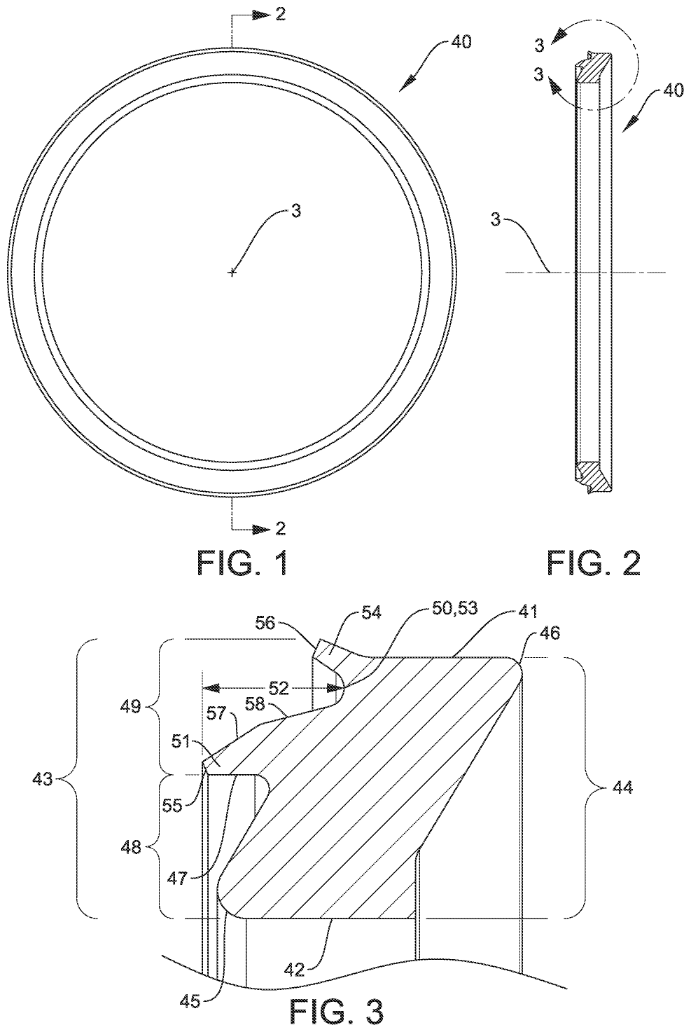

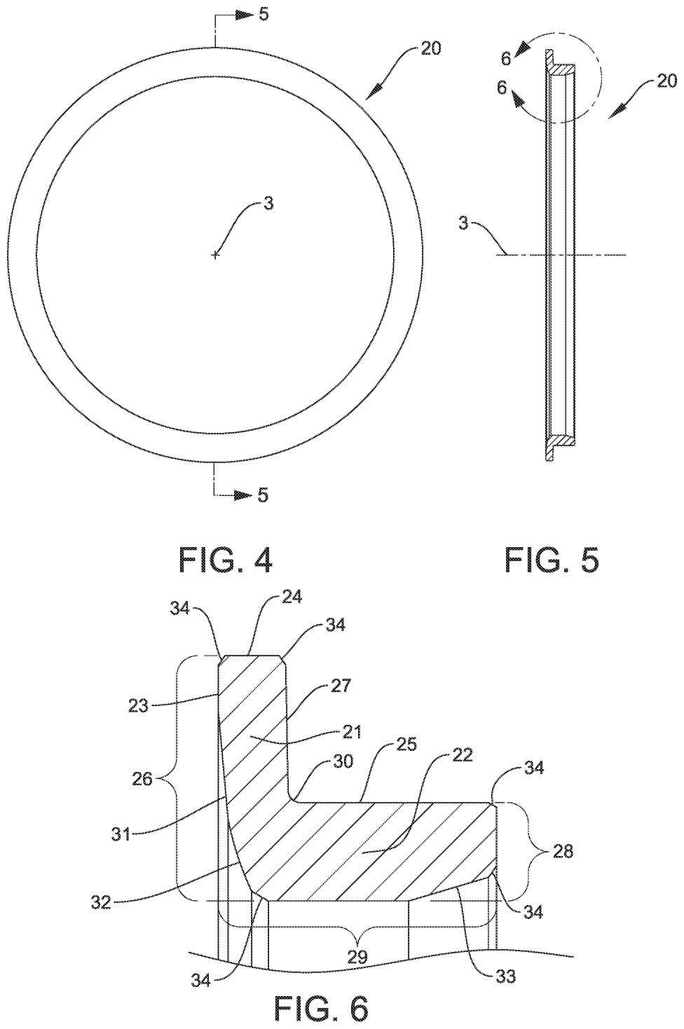

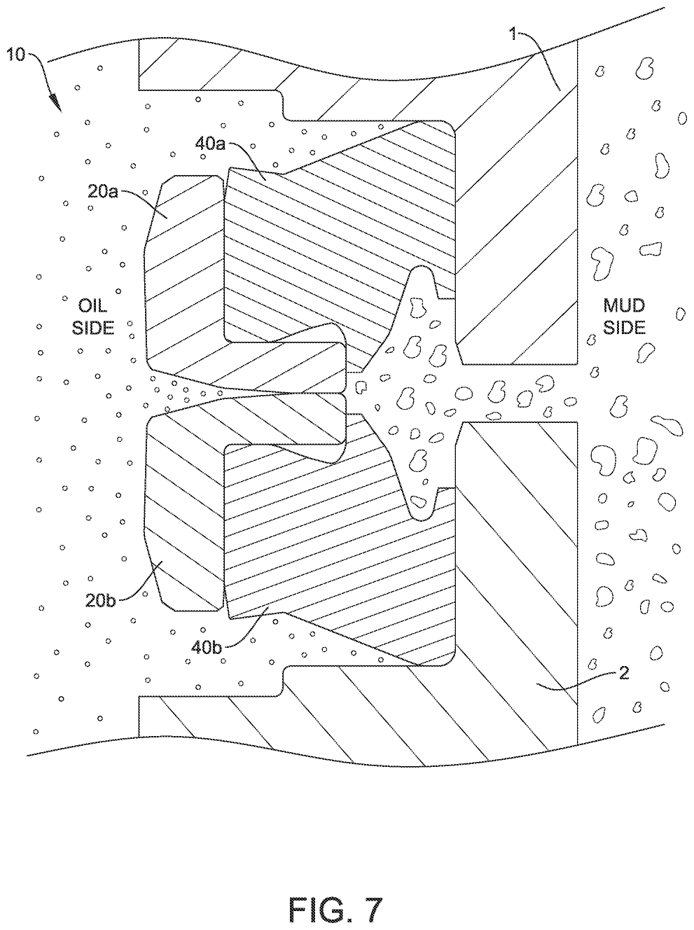

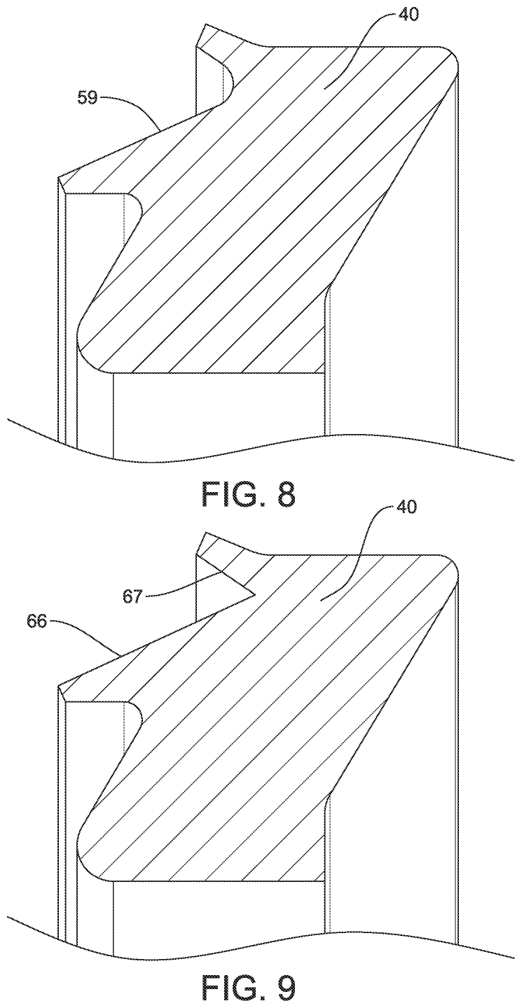

FIGS. 1-3 are of an exemplary elastomeric ring 20 of a face seal assembly 10 of the present invention. FIGS. 4-6 are of an exemplary metal ring of the face seal assembly 10 of the present invention. FIG. 7 shows the exemplary face seal assembly 10 using the structures of FIGS. 1-6 installed in a first housing 1 and second housing 2 illustrating the sealing separation of the oil side from the mud side.

Referring generally to FIGS. 1-7, the face seal assembly 10 comprises a pair of metal rings 20a, 20b, where each metal ring 20 of the pair of metal rings are identical, and a pair of elastomeric rings 40a, 40b, where each elastomeric ring 40 of the pair of elastomeric rings are identical. The pair of metal rings and the pair of elastomeric rings are configured to be disposed about a common axis of rotation 3. As best seen in FIG. 7, one of the metal rings of the pair of metal rings is disposed directly opposite of the other metal ring and are abutting one another in a sealing arrangement. One of the elastomeric rings of the pair of elastomeric rings is attached to one of the metal rings of the pair of elastomeric rings, and the other elastomer ring is attached to the other metal ring.

As best shown in FIGS. 3 and 6, a cross section taken through and aligned with the common axis of rotation slices the pair of metal rings and the pair of elastomeric rings respectively defining a metal ring cross section as shown in FIG. 6 and an elastomeric ring cross section as shown in FIG. 3.

Referring to FIG. 6, the metal ring cross section is L-shaped having a first section 21 extending perpendicularly from a second section 22. The first section extends away from the common axis of rotation 3 and the second section extends along the common axis of rotation 3. The L-shaped metal ring cross section defines an inner corner 30 between the first and second sections. The inner corner 30 can be radius or even a chamfer. The pair of metal rings are configured to be biased towards one another by the pair of elastomeric rings when the face seal assembly is in an installed state as shown in FIG. 7. Each first section of the pair of metal rings comprises a lapped surface 23 configured to abut one another in the sealing arrangement.

Each metal ring comprises an outer diameter surface 24 of the first section and an outer diameter surface 25 of the second section that is smaller in diameter in comparison to the outer diameter surface 24 of the first section. An inside side 26 of the first section is opposite an outside side 27 of the first section and an outside side 28 of the second section. The outside side 28 of the second section extends outwardly beyond the outside side 27 of the first section. An inner diameter side 29 of the second side is opposite the outer diameter 24 of the first section and the outer diameter 25 of the second section. The inner corner 30 connects the outside side 27 of the first section to the outer diameter surface 25 of the second section. The lapped surface 23 is part of the inside side 26 of the first section.

Alternatively, the inside side 26 of the first section may comprise a first angled surface 31 adjacent to the lapped surface 23. This first angled surface 31 may extend fully to the inner diameter side 29 or may include a second angled surface 32 as shown herein where the second angled surface 32 is adjacent to the first angled surface 31. Furthermore, the inner diameter side 29 of the second side may comprise a third angled surface 33 adjacent to the outside side 28 of the second section. Also seen are a multitude of chamfers 34 that prevent sharp corners. It is understood by those skilled in the art that these chamfers could also be radiuses. It will also be understood by those skilled in the art that a number of additional angled or curved surfaces could be used to form the metal ring, as this teaching is not to be limited to the exact embodiment shown herein.

Referring to FIG. 3, the elastomeric ring cross section defines an outer diameter surface 41 opposite an inner diameter surface 42 which are then disposed between an outside side 43 opposite an inside side 44. An inner corner 45 connects the outside side 43 and the inner diameter surface 42 and an outside corner 46 connects the outer diameter surface 41 and the inside side 44.

The outside side 43 of the elastomer ring is divided by a second inner diameter surface 47 definingly separating a metal ring engagement side 48 from an environmentally exposed side 49. The environmentally exposed side 49 comprises an annularly-shaped concave valley 50 formed in the elastomeric ring, which is facing the annularly-shaped concave valley of its oppositely disposed respective elastomeric ring of the pair of elastomeric rings of the face seal assembly. The annularly-shaped concave valley 50 starts from a first annular lip 51 and extends to a maximum offset distance 52 at an annular bottom 53 of the annularly-shaped concave valley and ends at a second annular lip 54. As shown with the arrows, the maximum offset distance 52 is measured parallel to the common axis of rotation. The second annular lip 54 is disposed further back from the first annular lip 51 in relation to a distance parallel to the common axis of rotation, which is true whether the elastomeric ring is the uninstalled state (FIG. 3) or in the installed state (FIG. 7).

The first annular lip 51 ends in a first annular flat section 55 and the second annular lip 54 ends in a second annular flat section 56. Referring back to FIG. 7, the face seal assembly is configured to be disposed between a first housing part 1 and a second housing part 2, wherein one of the housing parts rotates about the common axis of rotation in relation to the other housing part. One of the elastomeric rings 40a is configured to engage and attach to the first housing part 1 and the other elastomeric ring 40b is configured to engage and attach to the second housing part 2. As shown in FIG. 3, the first annular flat section is frustoconically-shaped in an uninstalled state but then in FIG. 7 is perpendicularly disposed in relation to the common axis of rotation when installed in its respective first or second housing parts in the installed state. Similarly, as shown in FIG. 3, the second annular flat section is frustoconically-shaped in the uninstalled state and then in FIG. 7 is perpendicularly disposed in relation to the common axis of rotation when installed in its respective first or second housing parts in the installed state.

It is important that the first and second annular flat sections 55 and 56 are at a perpendicular angle (90 degrees) or an obtuse angle (greater than 90 degrees) in comparison to their respective mating surfaces of the metal ring or housing part. Otherwise, pressure build up from the mud and other contaminants would be able to work their way under the lips 51 and 56, whereas a flat presenting surface that is at a perpendicular angle or an obtuse angle prevents this from occurring. In other words, one skilled in the art would not want to use a radiused or rounded end of the lips 51 and 54 as this would not work as effectively as the present invention teaches.

As can be seen in FIG. 7, the inner corner 45 of each elastomeric ring of the pair of elastomeric rings is configured to be disposed at the inner corner 30 of its respective metal ring of the pair of metal rings. Also, the second inner diameter surface 47 of the elastomeric ring is configured to at least partially abut the outer diameter 24 of the first section of the metal ring of the face seal assembly. Also, the metal ring engagement side 48 of each elastomeric ring is configured to at least partially abut the outside side 27 of the first section 21 of its respective metal ring.

When looking at FIG. 3, the elastomeric ring cross section is generally parallelogram-shaped in the uninstalled state. Then, when the face seal assembly 10 is installed in the housings as shown in FIG. 7, the elastomeric properties enable the elastomeric seal to deform and create a bias that forces the lapped surfaces of the metal rings to abut one another to create the seal between the oil side and mud side. The elastomeric ring can be made from rubber, polymers, NBR (nitrile butadiene rubber), HNBR (Hydrogenated Acrylonitrile-Butadiene Rubber), VMQ (silicone) and FKM/FPM (fluorocarbon-based fluoroelastomer and fluorocarbon rubber). The metal ring is made of metal, but can be steel, stainless steel, aluminum and cast iron.

Referring again to FIG. 3, annularly-shaped concave valley 50 has two surfaces, first surface 57 and second surface 58. At the annular bottom 53 is a radius. It is understood by those skilled in the art that this radius may be larger or smaller. Also, the radius may be a chamfer, curve or any other shape that forms the annularly-shaped concave valley 50.

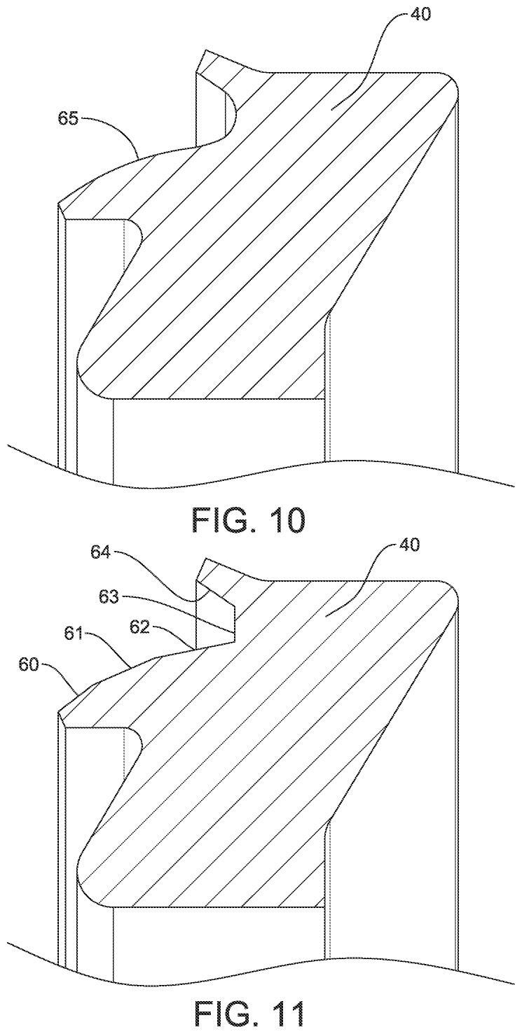

Also, it is understood by those skilled in the art that surfaces 57 and 58 could be simplified into just a single surface 59, as is shown in FIG. 8. Also, it will be understood by those skilled in the art that 2, 3, 4 or any number of surfaces could be used, such as shown in FIG. 11 where surfaces 60, 61, 62, 63, 64 comprise the annularly-shaped concave valley 50. Also, it will be understood by those skilled in the art that the surfaces could be curved into one flowing curve 65 as shown in FIG. 10. Also, it will be understood by those skilled in the art that the annularly-shaped concave valley 50 may be simplified into just two surfaces 66 and 67 as shown in FIG. 9. As can be appreciated by those skilled in the art, there are a multitude of variations that can be created based upon this teaching of the annularly-shaped concave valley 50 as this disclosure is not to be limited to the exact forms described and shown herein, but be limited by a broad interpretation of the claims in the spirit of this disclosure.

As can now be appreciated by those skilled in the art after reading this disclosure, the present invention relates to a face seal assembly that uses a novel shape of the elastomeric ring surface exposed to the environmental contaminants to then advantageously improve its sealing characteristics. This is accomplished through the annularly-shaped concave valley 50 that allows dirt, water, mud, debris (i.e. environmental contaminants) to create a pressure against the sealing lips 51 and 54 to increase the sealing effects.

It is also worth noting that great pressure may be created when the face seal assembly 10 is in use that is acting against the annularly-shaped concave valley 50. Therefore, it is important that the elastomeric ring 40 not have voids or sections of material removed from within the elastomeric ring itself that are disposed behind the annularly-shaped concave valley 50, such as pockets or other hollowed out features, as these could collapse under the immense pressure resulting in a seal failure. In other words, there is constant elastomeric material from the beginning of the annularly-shaped concave valley 50 to then the outside side 44 to ensure dimensional stability of the elastomeric ring.

Although several embodiments have been described in detail for purposes of illustration, various modifications may be made to each without departing from the scope and spirit of the invention. Accordingly, the invention is not to be limited, except as by the appended claims.

### NUMERALS

1 first housing part
2 second housing part
3 common axis of rotation
10 face seal assembly
20 metal ring
21 first section, metal ring
22 second section, metal ring
23 lapped surface, metal ring
24 outer diameter surface of the first section, metal ring
25 outer diameter surface of the second section, metal ring
26 inside side of first section, metal ring
27 outside side of first section, metal ring
28 outside side of second section, metal ring
29 inner diameter side, metal ring
30 inner corner, metal ring
31 first angled surface, metal ring
32 second angled surface, metal ring
33 third angled surface, metal ring
34 chamfers, metal ring
40 elastomeric ring
41 outer diameter surface, elastomeric ring
42 inner diameter surface, elastomeric ring
43 outside side, elastomeric ring
44 inside side, elastomeric ring
45 inner corner, elastomeric ring
46 outside corner, elastomeric ring
47 second inner diameter surface, elastomeric ring
48 metal ring engagement side, elastomeric ring
49 environmentally exposed side, elastomeric ring
50 annularly-shaped concave valley, elastomeric ring
51 first annular lip, elastomeric ring
52 maximum offset distance, elastomeric ring
53 annular bottom, concave valley, elastomeric ring
54 second annular lip, elastomeric ring
55 first annular flat section, elastomeric ring
56 second annular flat section, elastomeric ring
57 first surface, annularly-shaped concave valley
58 second surface, annularly-shaped concave valley
59 single surface, annularly-shaped concave valley
60 first surface, annularly-shaped concave valley
61 second surface, annularly-shaped concave valley
62 third surface, annularly-shaped concave valley
63 fourth surface, annularly-shaped concave valley
64 fifth surface, annularly-shaped concave valley
65 curved surface, annularly-shaped concave valley
66 first surface, annularly-shaped concave valley
67 second surface, annularly-shaped concave valley

What is claimed is:

1. A face seal assembly, comprising:
a pair of metal rings, where each metal ring of the pair of metal rings are identical; and
a pair of elastomeric rings, where each elastomeric ring of the pair of elastomeric rings are identical;
wherein the pair of metal rings and the pair of elastomeric rings are configured to be disposed about a common axis of rotation;
wherein one of the metal rings of the pair of metal rings is disposed directly opposite of the other metal ring and are abutting one another in a sealing arrangement;
wherein one of the elastomeric rings of the pair of elastomeric rings is attached to one of the metal rings of the pair of elastomeric rings, and the other elastomer ring is attached to the other metal ring;
wherein a cross section taken through and aligned with the common axis of rotation slices the pair of metal rings and the pair of elastomeric rings respectively defining a metal ring cross section and an elastomeric ring cross section;
wherein the metal ring cross section is L-shaped having a first section extending perpendicularly from a second section, wherein the first section extends away from the common axis of rotation and the second section extends along the common axis of rotation, wherein the L-shaped metal ring cross section defines an inner corner between the first and second sections;
wherein the pair of metal rings are configured to be biased towards one another by the pair of elastomeric rings when the face seal assembly is in an installed state;
wherein each first section of the pair of metal rings comprises a lapped surface configured to abut one another in the sealing arrangement;
wherein the elastomeric ring cross section defines an outer diameter surface opposite an inner diameter surface disposed between an outside side opposite an inside side, wherein an inner corner of the elastomeric ring connects the outside side and the inner diameter surface and an outside corner connects the outer diameter surface and the inside side;
wherein the outside side of the elastomer ring is divided by a second inner diameter surface definingly separating a metal ring engagement side from an environmentally exposed side; and
wherein the environmentally exposed side comprises an annularly-shaped concave valley formed in the elastomeric ring, which is facing the annularly-shaped concave valley of its oppositely disposed respective elastomeric ring of the pair of elastomeric rings of the face seal assembly.

2. The face seal assembly of claim 1, wherein the annularly-shaped concave valley starts from a first annular lip and extends to a maximum offset distance at an annular bottom of the annularly-shaped concave valley and ends at a second annular lip, wherein the maximum offset distance is measured parallel to the common axis of rotation.

3. The face seal assembly of claim 2, wherein the second annular lip is disposed further back from the first annular lip in relation to a distance parallel to the common axis of rotation.

4. The face seal assembly of claim 3, wherein the first annular lip ends in a first annular flat section.

5. The face seal assembly of claim 4, wherein the second annular lip ends in a second annular flat section.

6. The face seal assembly of claim 5, wherein the face seal assembly is configured to be disposed between a first housing part and a second housing part, wherein one of the housing parts rotates about the common axis of rotation in relation to the other housing part, wherein one of the elastomeric rings is configured to engage and attach to the first housing part and the other elastomeric ring is configured to engage and attach to the second housing part.

7. The face seal assembly of claim 6, wherein the first annular flat section is frustoconically-shaped in an uninstalled state and is perpendicularly disposed in relation to the common axis of rotation when installed in its respective first or second housing parts in the installed state.

8. The face seal assembly of claim 7, wherein the second annular flat section is frustoconically-shaped in the uninstalled state and is perpendicularly disposed in relation to the common axis of rotation when installed in its respective first or second housing parts in the installed state.

9. The face seal assembly of claim 1, wherein the inner corner of each elastomeric ring of the pair of elastomeric rings is configured to be disposed at the inner corner of its respective metal ring of the pair of metal rings.

10. The face seal assembly of claim 1, wherein the metal ring engagement side of each elastomeric ring is configured to at least partially abut the outside side of the first section of its respective metal ring.

11. The face seal assembly of claim 1, wherein each metal ring of the pair of metal rings comprises: an outer diameter surface of the first section; an outer diameter surface of the second section that is smaller in diameter in comparison to the outer diameter surface of the first section; an inside side of the first section opposite an outside side of the first section and an outside side of the second section, where the outside side of the second section extends outwardly beyond the outside side of the first section; and an inner diameter side of the second side that is opposite the outer diameter surface of the first section and the outer diameter surface of the second section.

12. The face seal assembly of claim 11, wherein the second inner diameter surface of the elastomeric ring is configured to at least partially abut the outer diameter surface of the first section of the metal ring of the face seal assembly.

13. The face seal assembly of claim 11, wherein the inner corner of the metal ring connects the outside side of the first section to the outer diameter surface of the second section.

14. The face seal assembly of claim 11, wherein the lapped surface is part of the inside side of the first section.

15. The face seal assembly of claim 1, wherein the elastomeric ring is free of pockets or hollowed out portions disposed behind the annularly-shaped concave valley.

16. A face seal assembly, comprising:
a pair of metal rings, where each metal ring of the pair of metal rings are identical; and
a pair of elastomeric rings, where each elastomeric ring of the pair of elastomeric rings are identical;
wherein the pair of metal rings and the pair of elastomeric rings are configured to be disposed about a common axis of rotation;
wherein one of the metal rings of the pair of metal rings is disposed directly opposite of the other metal ring and are abutting one another in a sealing arrangement;
wherein one of the elastomeric rings of the pair of elastomeric rings is attached to one of the metal rings of the pair of elastomeric rings, and the other elastomer ring is attached to the other metal ring;
wherein a cross section taken through and aligned with the common axis of rotation slices the pair of metal rings and the pair of elastomeric rings respectively defining a metal ring cross section and an elastomeric ring cross section;
wherein the metal ring cross section is L-shaped having a first section extending perpendicularly from a second section, wherein the first section extends away from the common axis of rotation and the second section extends along the common axis of rotation, wherein the L-shaped metal ring cross section defines an inner corner between the first and second sections;
wherein the pair of metal rings are configured to be biased towards one another by the pair of elastomeric rings when the face seal assembly is in an installed state;
wherein each first section of the pair of metal rings comprises a lapped surface configured to abut one another in the sealing arrangement;
wherein the elastomeric ring cross section defines an outer diameter surface opposite an inner diameter surface disposed between an outside side opposite an inside side, wherein an inner corner of the elastomeric ring connects the outside side and the inner diameter surface and an outside corner connects the outer diameter surface and the inside side;
wherein the outside side of the elastomer ring is divided by a second inner diameter surface definingly separating a metal ring engagement side from an environmentally exposed side;
wherein the second inner diameter surface of the elastomeric ring is configured to at least partially abut an outer diameter surface of the first section of the metal ring of the face seal assembly;
wherein the environmentally exposed side comprises an annularly-shaped concave valley formed in the elastomeric ring, which is facing the annularly-shaped concave valley of its oppositely disposed respective elastomeric ring of the pair of elastomeric rings of the face seal assembly; and
wherein the elastomeric ring is free of pockets or hollowed out portions disposed behind the annularly-shaped concave valley.

17. The face seal assembly of claim 16, wherein the inner corner of each elastomeric ring of the pair of elastomeric rings is configured to be disposed at the inner corner of its respective metal ring of the pair of metal rings, and wherein the metal ring engagement side of each elastomeric ring is configured to at least partially abut the outside side of the first section of its respective metal ring.

18. A face seal assembly, comprising:
a pair of metal rings, where each metal ring of the pair of metal rings are identical; and
a pair of elastomeric rings, where each elastomeric ring of the pair of elastomeric rings are identical;
wherein the pair of metal rings and the pair of elastomeric rings are configured to be disposed about a common axis of rotation;
wherein one of the metal rings of the pair of metal rings is disposed directly opposite of the other metal ring and are abutting one another in a sealing arrangement;
wherein one of the elastomeric rings of the pair of elastomeric rings is attached to one of the metal rings of the pair of elastomeric rings, and the other elastomer ring is attached to the other metal ring;
wherein a cross section taken through and aligned with the common axis of rotation slices the pair of metal rings and the pair of elastomeric rings respectively defining a metal ring cross section and an elastomeric ring cross section;
wherein the metal ring cross section is L-shaped having a first section extending perpendicularly from a second section, wherein the first section extends away from the common axis of rotation and the second section extends along the common axis of rotation, wherein the L-shaped metal ring cross section defines an inner corner between the first and second sections;
wherein the pair of metal rings are configured to be biased towards one another by the pair of elastomeric rings when the face seal assembly is in an installed state;
wherein each first section of the pair of metal rings comprises a lapped surface configured to abut one another in the sealing arrangement;
wherein the elastomeric ring cross section defines an outer diameter surface opposite an inner diameter surface disposed between an outside side opposite an inside side, wherein an inner corner of the elastomeric ring connects the outside side and the inner diameter surface and an outside corner connects the outer diameter surface and the inside side;
wherein the outside side of the elastomer ring is divided by a second inner diameter surface definingly separating a metal ring engagement side from an environmentally exposed side;
wherein the environmentally exposed side comprises an annularly-shaped concave valley formed in the elastomeric ring, which is facing the annularly-shaped concave valley of its oppositely disposed respective elastomeric ring of the pair of elastomeric rings of the face seal assembly;
wherein the annularly-shaped concave valley starts from a first annular lip and extends to a maximum offset distance at an annular bottom of the annularly-shaped concave valley and ends at a second annular lip, wherein the maximum offset distance is measured parallel to the common axis of rotation;
wherein the second annular lip is disposed further back from the first annular lip in relation to a distance parallel to the common axis of rotation;
wherein the first annular lip ends in a first annular flat section; and
wherein the second annular lip ends in a second annular flat section.

19. The face seal assembly of claim 18, wherein the face seal assembly is configured to be disposed between a first housing part and a second housing part, wherein one of the housing parts rotates about the common axis of rotation in relation to the other housing part, wherein one of the elastomeric rings is configured to engage and attach to the first housing part and the other elastomeric ring is configured to engage and attach to the second housing part.

20. The face seal assembly of claim 19, wherein the first annular flat section is frustoconically-shaped in an uninstalled state and is perpendicularly disposed in relation to the common axis of rotation when installed in its respective first or second housing parts in the installed state, and wherein the second annular flat section is frustoconically-shaped in the uninstalled state and is perpendicularly disposed in relation to the common axis of rotation when installed in its respective first or second housing parts in the installed state.
